(19) United States
(12) Patent Application Publication
(10) Pub. No.: US 2018/0124287 A1
(43) Pub. Date: May 3, 2018

(54) DEVICES, SYSTEMS, AND METHODS FOR PRINT-PROCESS-CONTROL VERIFICATION USING COLOR-MANAGEMENT KNOWLEDGE OF A PRINTING PROCESS

(71) Applicant: Onyx Graphics, Inc., Salt Lake City, UT (US)

(72) Inventors: Maxim Wasyl Derhak, Brighton, NY (US); Lin Luo, Draper, UT (US)

(21) Appl. No.: 15/697,217

(22) Filed: Sep. 6, 2017

Related U.S. Application Data
(60) Provisional application No. 62/414,487, filed on Oct. 28, 2016.

(51) Int. Cl. H04N 1/60

(52) U.S. Cl. CPC H04N 1/6058

(57) ABSTRACT

Devices, systems, and methods obtain a color-management profile for a printing device, determine a gamut for the printing device based on the color-measurement profile, and identify target measurement points in the gamut. The target measurement points may include a white point, a black point, a gray-center point, a dark-color point, a saturated-color point, a saturated-gray point, a light-color point, a half-color point, a mid-saturated-color point, a mid-light-color point, a mid-half-color point, a mid-dark-color point, a half-saturated-color-white point, a light-saturated-color-white point, a half-saturated-color-black point, and one or more gamut points (e.g., gamut-boundary or near-gamut-boundary points).

### CROSS-REFERENCE TO RELATED APPLICATIONS

This application claims the benefit of U.S. Application No. 62/414,487, which was filed on Oct. 28, 2016.

### BACKGROUND

### Technical Field

This application generally relates to color management in printing processes.

### Background

A color-management system can help to achieve a good color match between devices.

### SUMMARY

Some embodiments of a system comprise one or more computer-readable media and one or more processors that are coupled to the one or more computer-readable media. The one or more processors are configured to cause the system to obtain a color-management profile for a printing device, determine a gamut for the printing device based on the color-measurement profile, and identify target measurement points in the gamut.

Some embodiments of a method comprise determining a gamut for a printing device based on a color-management profile of the printing device and identifying one or more target measurement points in the gamut.

Some embodiments of one or more computer-readable storage media store computer-executable instructions that, when executed by one or more computing devices, cause the one or more computing devices to determine a gamut of a printing device based on a color-management profile of the printing device and select one or more target measurement points in the gamut.

### BRIEF DESCRIPTION OF THE DRAWINGS

FIG. 1 illustrates an example embodiment of a system for color management.

FIG. 2 illustrates an example embodiment of an operational flow for color management.

FIGS. 3A-B illustrate example embodiments of coordinate representations of a gamut.

FIGS. 4A-C illustrate example embodiments of color-measurements points in gamuts.

FIG. 5 illustrates an example embodiment of an operational flow for determining target measurement points.

FIG. 6 illustrates an example embodiment of target measurement points in a gamut.

FIG. 7 illustrates an example embodiment of an operational flow for determining target measurement points.

FIG. 8 illustrates an example embodiment of color-vector projection.

FIG. 9 illustrates an example embodiment of a system for color management.

### DETAILED DESCRIPTION

The following paragraphs describe certain explanatory embodiments. Other embodiments may include alternatives, equivalents, and modifications. Additionally, the explanatory embodiments may include several novel features, and a particular feature may not be essential to some embodiments of the devices, systems, and methods that are described herein.

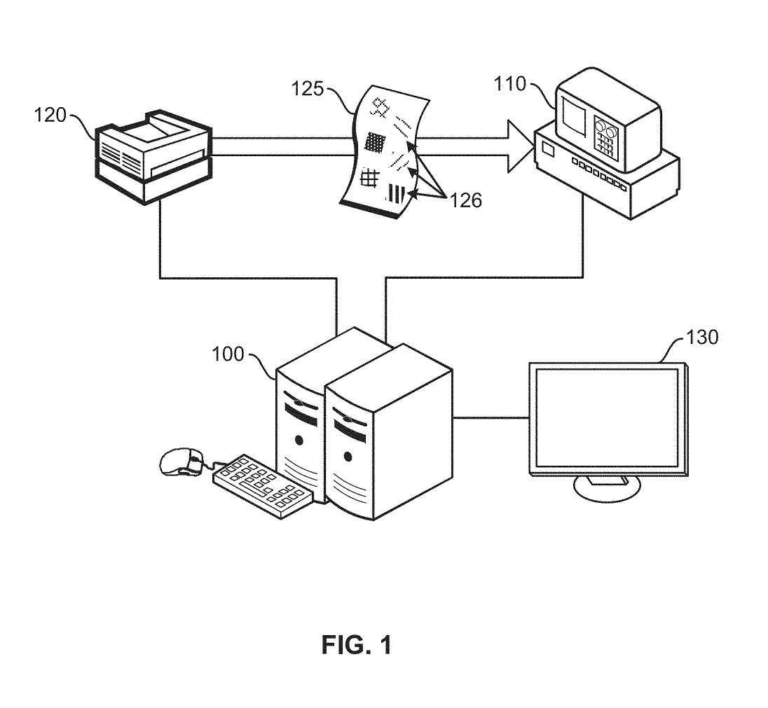

FIG. 1 illustrates an example embodiment of a system for color management. The system includes one or more color-management devices 100, each of which is a specially-configured computing device (e.g., a desktop computer, a laptop computer, a server); a color-measurement device 110; a printing device 120 (e.g., an inkjet printer, a laser printer, a three-dimensional (3D) printer); and a display device 130. The printing device 120 outputs a swatch 125, which includes one or more color patches 126.

The one or more color-management devices 100 store a color-management profile for the printing device 120. The color-management profile includes transforms that describe conversions of printing-device values to color measurements and conversions of color measurements to printing-device values. The one or more color-management devices 100 use the color-management profile to calculate the gamut of colors that can be output by the printing device 120. Also, the one or more color-management devices 100 can use the calculated gamut to identify a set of color-measurement points inside the gamut. The identified color-measurement points are target measurement points. Each of these target measurement points describes a respective color in the gamut, and they include achromatic colors, chromatic colors, or both. The one or more color-management devices 100 use the color-management profile to calculate printing-device values for each of the target measurement points, and the one or more color-management devices 100 send a print job that includes patches of the calculated printing-device values to the printing device 120.

The printing device 120 produces the swatch 125 based on the print job. The swatch 125 includes one or more color patches 126, each of which was produced using a respective one of the calculated printing-device values.

The color-measurement device 110 measures each of the color patches 126 on the swatch 125, thereby generating a respective color measurement for each color patch 126. The color-measurement device 110 sends the color measurements to the one or more color-management devices 100. In some embodiments, a user can manually input the color measurements into the one or more color-management devices 100.

The one or more color-management devices 100 compute color differences between the respective color measurement of a color patch 126 and the corresponding target measurement point. The one or more color-management devices 100 then generate a report on the differences and present the report in a user interface on the display device 130.

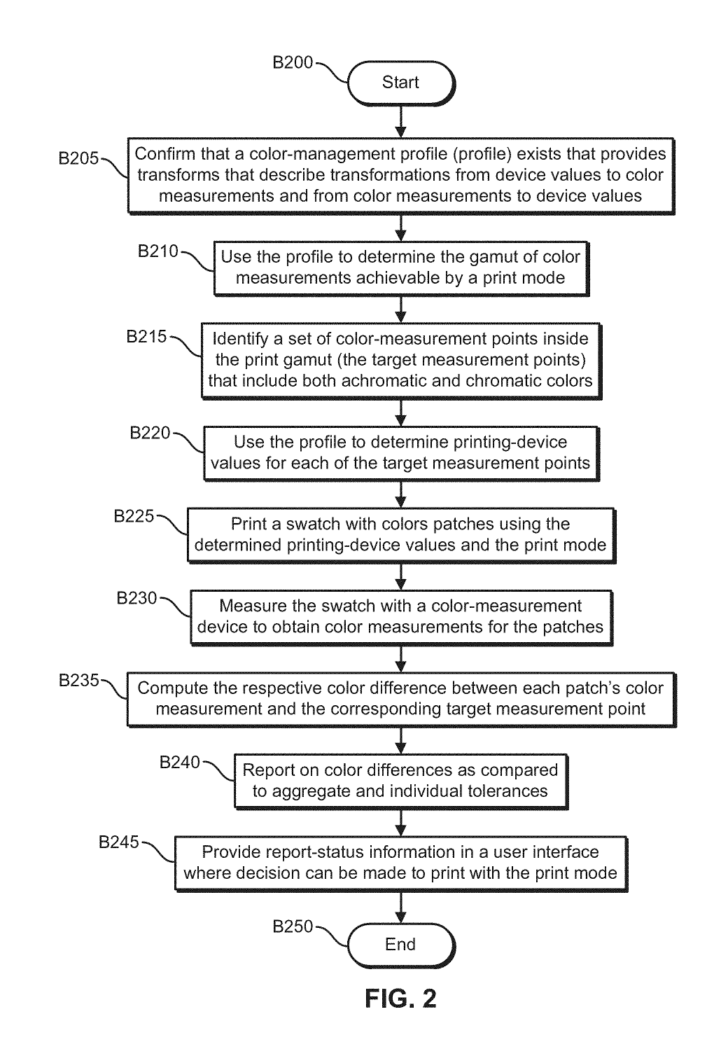

FIG. 2 illustrates an example embodiment of an operational flow for color management. The blocks of this operational flow and the other operational flows that are described herein may be performed by one or more devices, for example the devices and systems that are described herein. Although the operational flows that are described herein are each presented in a certain order, some embodiments may perform at least some of the operations in different orders than the presented orders. Examples of possible different orderings include concurrent, overlapping, reordered, simultaneous, incremental, and interleaved orderings. Thus, other embodiments of the operational flows that are described herein may omit blocks, add blocks, change the order of the blocks, combine blocks, or divide blocks into more blocks.

Furthermore, although the descriptions of this operation flow and the other operational flows that are described herein use a color-management device, other embodiments of these operational flows may use two or more color-management devices or one or more other specially-configured computing devices.

The flow starts in block B200, and then proceeds to block B205. In block B205, a color-management device confirms that, for a print mode of a printing device, it has a color-management profile that includes transforms that describe transformations from printing-device values to color measurements and from color measurements to printing-device values. The color-management profile may be an ICC profile, which is a profile that conforms to standards established by the International Color Consortium (ICC).

Next, in block B210, the color-management device uses the color-management profile to determine the gamut of color measurements that are achievable by the printing device in the print mode, and each color measurement describes a respective color that can be output by the printing device in the print mode. The color-management profile may explicitly define the gamut, the color-management device may iteratively transform printing-device values to color measurements to identify the color measurements that define the gamut's boundary, or the color-management device may identify a color as “in gamut” if applying a color measurement to the color-measurement-to-printing-device-value transform and then to the printing-device-value-to-color-measurement transform produces nearly the same color measurement.

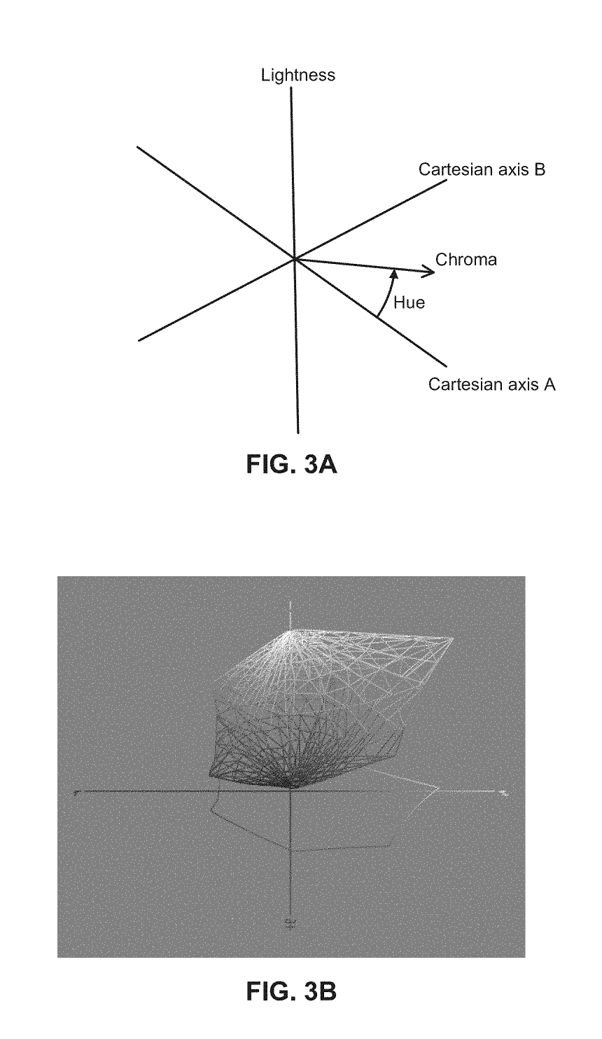

Additionally, the gamut may be represented in three dimensions: lightness, chroma, and hue. The gamut may use a Cartesian coordinate system to represent these dimensions or may use a polar coordinate system to represent these dimensions. Also, the hue may be corrected for perceptual uniformity. FIGS. 3A-B illustrate example embodiments of coordinate representations of a gamut.

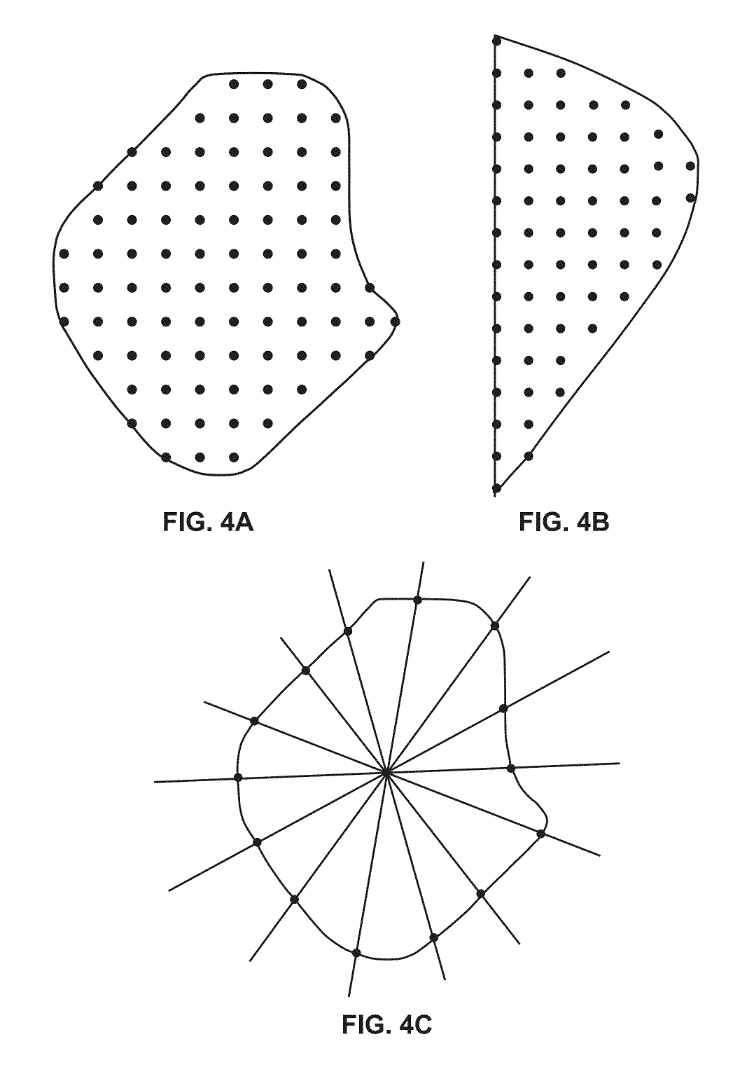

The flow then moves to block B215, where the color-management device identifies a set of color-measurement points inside the print gamut that include achromatic colors, chromatic colors, or both. These identified color-measurement points are the target measurement points. For example, the color-management device may identify an even sampling of color-measurement points within the gamut. An example of even sampling points in a gamut that uses a Cartesian coordinate system is shown in FIG. 4A.

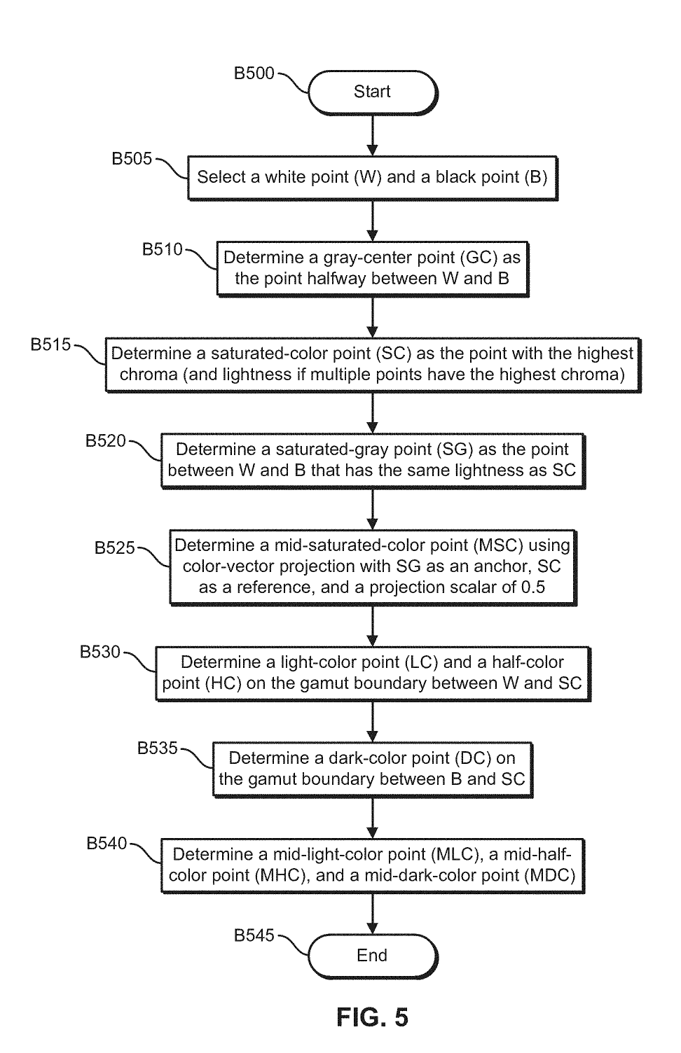

Additionally, if the gamut is represented by lightness, chroma, and hue, then achromatic points and chromatic points can be identified in a number of ways. For example, the color-management device may evenly sample lightness and choma points with the same hue. An example of even sampling points on a hue plane, which defines all of the points in the gamut that have the same hue, is shown in FIG. 4B. Also for example, the color-management device may sample near-maximally-saturated and maximally-saturated colors, for example as shown in FIG. 4C. Moreover, the color-management device may identify particular color-measurement points, for example as described in FIG. 5.

The flow then proceeds to block B220, where the color-management device uses the color-management profile to determine printing-device values for each of the target measurement points (color-measurement points). Next, in block B225, the color-management device sends a print job that includes respective patches of the printing-device values to the printing device, which prints a swatch with colors patches using the printing-device values and the print mode.

Next, the flow moves to block B230, where the color-measurement device measures the swatch to obtain respective color measurements for the color patches. The color measurements are then provided to the color-management device (e.g., via a network, by manual entry). Then in block B235, the color-management device computes the respective color difference between each patch's color measurement, as received from the color-measurement device, and the corresponding target measurement point.

The flow then moves to block B240, where the color-management device generates a report on color differences as compared to aggregate and individual tolerances. For example, the report-status information that is included in the report can identify the differences between each patch's color measurement, as received from the color-measurement device, and the corresponding target measurement point. Also, the report can describe the gamut of the printing device and can indicate areas of the printing device's gamut that are not included in another gamut or that are not mapped to by the color-measurement-to-device-value transform. For example, the report can indicate that the gamut of the printing device includes areas that are not included in the CMYK gamut, or the report can indicate that the color-measurement-to-device-value transform in the device's color-management profile does not map to some areas of the gamut of the printing device. Thus, the report can indicate unused areas of the printing device's gamut.

Next, in block B245, the color-management device provides report-status information in a user interface, which allows a user to input a command to print with the print mode. For example, a user can initiate the printing of a print job in the print mode, and, in response, a user interface that displays the report-status information and a “print” control is presented to the user. The report-status information can allow the user to determine if the printing device functions well enough for the desired printing to be performed. Finally, the flow ends in block B250.

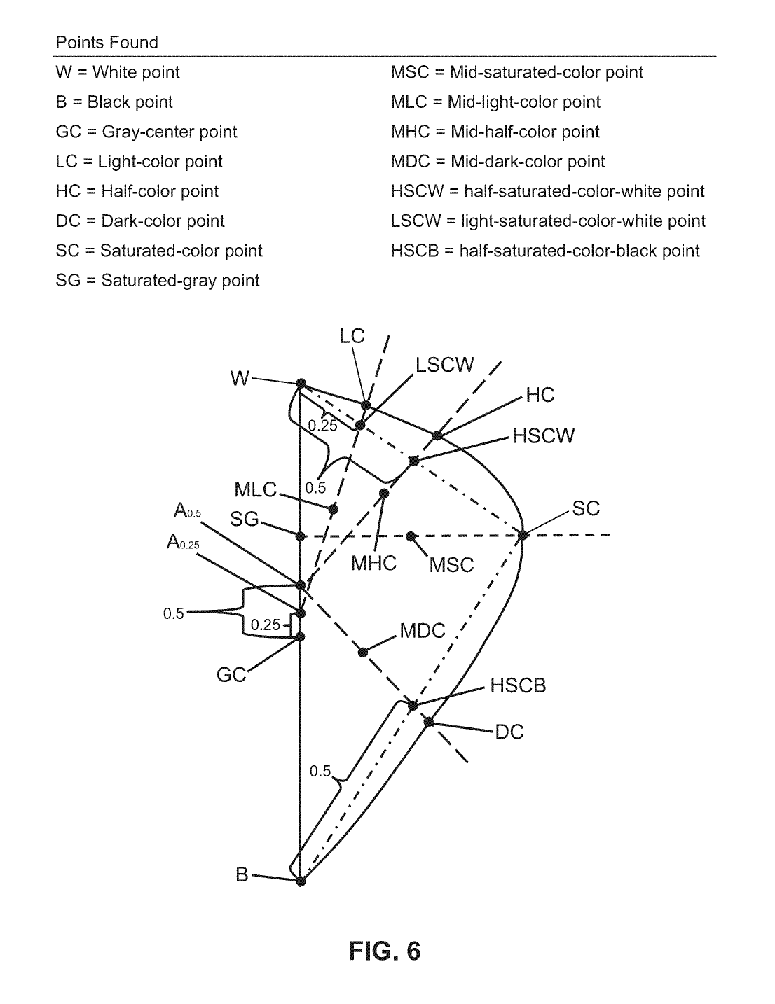

FIG. 5 illustrates an example embodiment of an operational flow for determining target measurement points. FIG. 6, which illustrates an example embodiment of target measurement points in a gamut, shows an example embodiment of some of the target measurement points that are determined by the operational flow of FIG. 5.

The flow starts in block B500 and moves to block B505, where the color-management device identifies a white point (W) and a black point (B). Next, in block B510, the color-management device determines the gray-center point (GC) as the point halfway between W and B. The flow then proceeds to block B515, where the color-management device determines the saturated-color point (SC) as the point with the highest chroma or, if multiple points have the highest chroma, the point with the highest chroma and the highest lightness. Then in block B520, the color-management device determines a saturated-gray point (SG) as the point between W and B that has the same lightness as SC. The flow moves to block B525, where the color-management device determines a mid-saturated-color point (MSC) using color-vector projection with SG as the anchor, with SC as a reference, and with a projection scalar of 0.5.

The flow then moves to block B530, where the color-management device determines a light-color point (LC) and a half-color point (HC) on the gamut boundary between W and SC. Next, in block B535, the color-management device determines a dark-color point (DC) on the gamut boundary between B and SC. The flow then moves to block B540, where the color-management device determines a mid-light-color point (MLC), a mid-half-color point (MHC), and a mid-dark-color point (MDC). Finally, the flow ends in block B545.

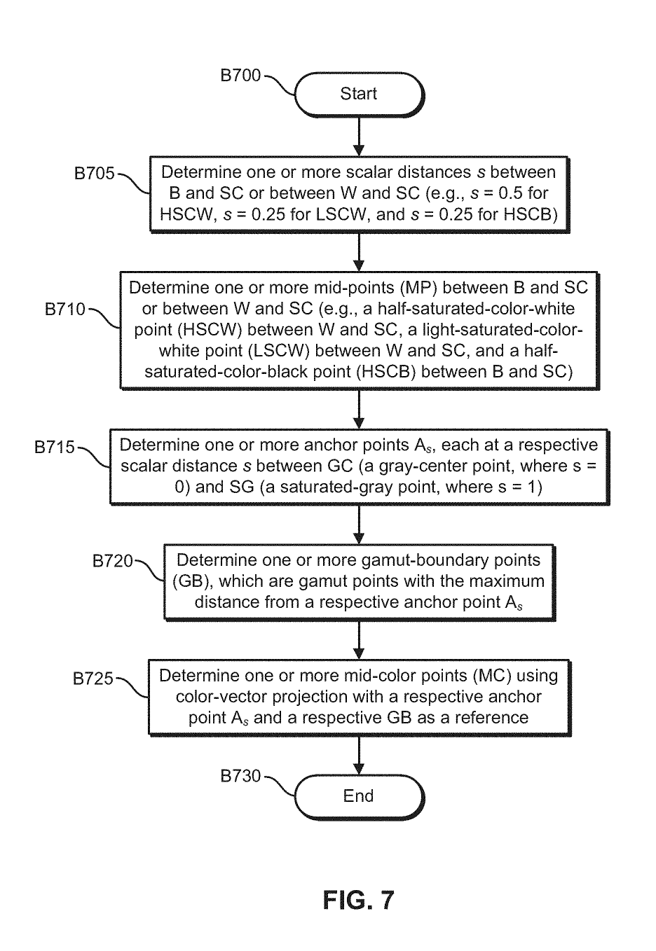

FIG. 7 illustrates an example embodiment of an operational flow for determining target measurement points. This operational flow determines a light-color point (LC), a half-color point (HC), a dark-color point (DC), a mid-light-color point (MLC), a mid-half-color point (MHC), and a mid-dark-color point (MDC). Also, this operational flow can be combined with one or more blocks of the operational flow in FIG. 5, and this operational flow can be used to implement some embodiments of blocks B530-B540 in FIG. 5. And FIG. 6 shows an example embodiment of some of the target measurement points that are determined by the operational flow of FIG. 5.

The flow starts in B700 and then moves to block B705. Next, in block B705, a color-management device determines one or more scalar distances s between B and SC or between W and SC. In this example, the scalar distance s is 0.5 for a half-saturated-color-white point (HSCW), the scalar distance s is 0.25 for a light-saturated-color-white point (LSCW), and the scalar distance s is 0.25 for a half-saturated-color-black point (HSCB). In B710, the color-management device uses the one or more scalar distances s to determine one or more mid-points (MP) between B and SC or between W and SC. For example, some embodiments of the color-management device determine the following MPs: HSCW, which is a MP between W and SC; LSCW, which is a MP between W and SC; and HSCB, which is a MP between B and SC.

The flow then proceeds to block B715, where the color-management device determines one or more anchor points Aₛ, each at a respective scalar distance s between GC (where s=0) and SG (where s=1). Then in block B720, the color-management device determines one or more gamut-boundary points (GB), which are gamut points with the maximum distance from a respective anchor point Aₛ. A GB can be determined using color-vector projection with a respective anchor point Aₛ and a respective MP as a reference. In the example in FIG. 6, LC is a GB that uses LSCW as a reference and anchor point A_{0.25}, HC is a GB that uses HSCW as a reference and anchor point A_{0.5}, and DC is a GB that uses HSCB as a reference and anchor point A_{0.5}.

Next, in block B725, the color-management device determines one or more mid-color points (MC) using color-vector projection with a respective anchor point Aₛ and a respective GB as a reference. In the example in FIG. 6, MHC is an MC at one-half of the distance between A_{0.5} and HC, MDC is an MC at one-half of the distance between A_{0.5} and DC, and MLC is an MC at one-half of the distance between A_{0.25} and LC. Finally, the flow ends in block B730.

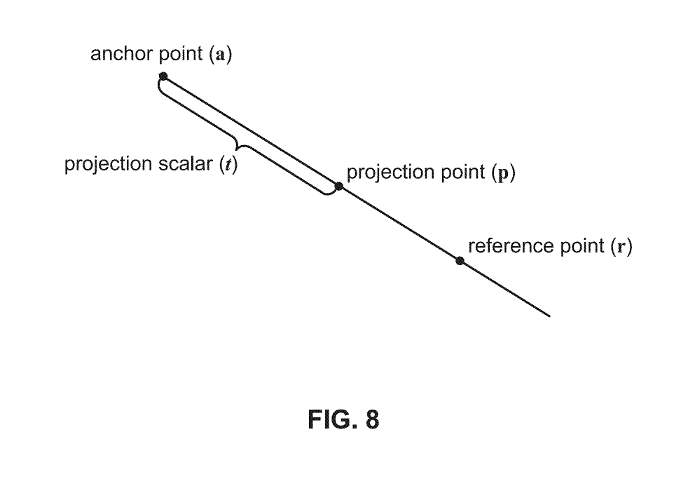

FIG. 8 illustrates an example embodiment of color-vector projection. The color-vector projection is a projection, in a scalar (t), from an anchor point (a) towards a reference point (r). The projection indicates a projection point (p), which can be described as follows: p=(1−t)a+tr.

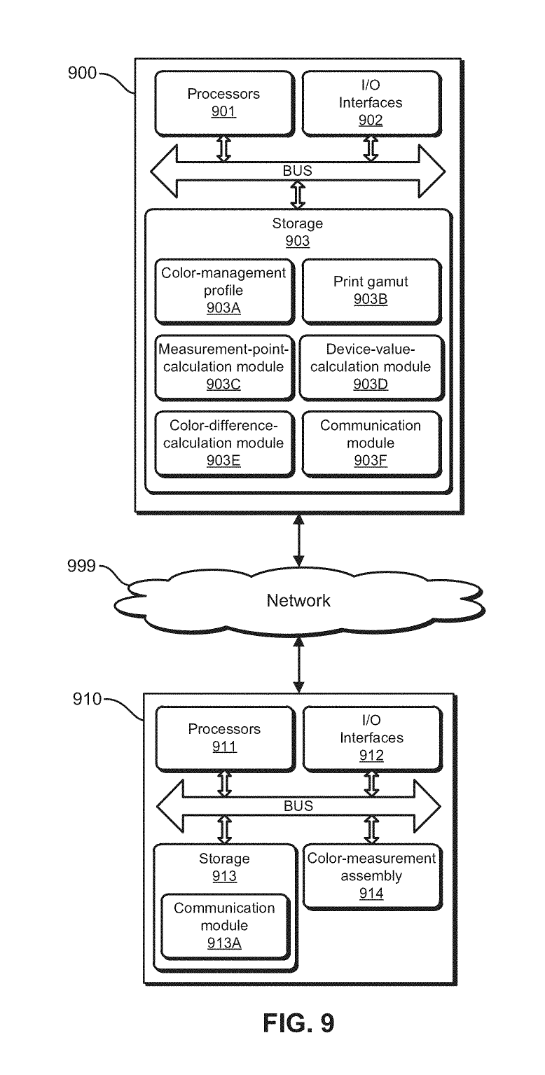

FIG. 9 illustrates an example embodiment of a system for color management. The system includes a color-management device 900, which is a specially-configured computing device, and a color-measurement device 910. In this embodiment, the devices communicate by means of one or more networks 999, which may include a wired network, a wireless network, a LAN, a WAN, a MAN, and a PAN. Also, in some embodiments the devices communicate by means of other wired or wireless channels.

The color-management device 900 includes one or more processors 901, one or more I/O components 902, and storage 903. Also, the hardware components of the color-management device 900 communicate by means of one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 901 include one or more central processing units (CPUs), which include microprocessors (e.g., a single core microprocessor, a multi-core microprocessor); graphics processing units (GPUs); application-specific integrated circuits (ASICs); field-programmable-gate arrays (FPGAs); digital signal processors (DSPs); or other electronic circuitry (e.g., other integrated circuits). The one or more processors 901 are configured to read and perform computer-executable instructions, such as instructions that are stored in the storage 903 (e.g., ROM, RAM, a module). The I/O components 902 include communication components (e.g., a GPU, a network-interface controller) that communicate with input and output devices, which may include a keyboard, a display device, a mouse, a printing device, a touch screen, a light pen, an optical-storage device, a scanner, a microphone, the color-measurement device 910, a drive, a controller (e.g., a joystick, a control pad), and devices in the network 999.

The storage 903 includes one or more computer-readable storage media. As used herein, a computer-readable storage medium, in contrast to a mere transitory, propagating signal per se, refers to a computer-readable media that includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). Also, as used herein, a transitory computer-readable medium refers to a mere transitory, propagating signal per se, and a non-transitory computer-readable medium refers to any computer-readable medium that is not merely a transitory, propagating signal per se. The storage 903, which may include both ROM and RAM, can store computer-readable data or computer-executable instructions.

The color-management device 900 also includes a color-management profile 903A, a print gamut 903B, a measurement-point-selection module 903C, a device-value-calculation module 903D, a color-difference-calculation module 903E, and a communication module 903F. A module includes logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the devices in the system include additional or fewer modules, the modules are combined into fewer modules, or the modules are divided into more modules. When the modules are implemented in software, the software can be stored in the storage 903.

The measurement-point-selection module 903C includes instructions that, when executed, or circuits that, when activated, cause the color-management device 900 to identify color-measurement points in the print gamut 903B (target measurement points), for example as described in blocks B210-B215 in FIG. 2, in blocks B505-B540 FIG. 5, or in blocks B705-B725 in FIG. 7.

The device-value-calculation module 903D includes instructions that, when executed, or circuits that, when activated, cause the color-management device 900 to transform color measurements to device values or to transform device values to color measurements using transforms that are included in the color-management profile 903A, for example as described in blocks B220 and B235 in FIG. 2.

The color-difference-calculation module 903E includes instructions that, when executed, or circuits that, when activated, cause the color-management device 900 to calculate differences between color measurements obtained from the color-measurement device 910 and the color measurements of color-measurement points (e.g., the color-measurement points that are identified by the measurement-point-selection module 903C), to generate a report that describes any differences, or to generate a user interface that includes report-status information, for example as described in blocks B235-B245 in FIG. 2.

The communication module 903F includes instructions that, when executed, or circuits that, when activated, cause the color-management device 900 to communicate with one or more other devices, for example the color-measurement device 910.

The color-measurement device 910 includes one or more processors 911, one or more I/O interfaces 912, storage 913, a communication module 913A, and a color-measurement assembly 914. The color-measurement assembly 914 includes one or more spectrophotometers. The communication module 913A includes instructions that, when executed, or circuits that, when activated, cause the color-measurement device 910 to receive a request for one or more color-measurements from a requesting device, retrieve requested color-measurements from the storage 913, or send retrieved color-measurements to the requesting device (e.g., the color-management device 900).

Also, some embodiments use one or more functional units to implement the above-described devices, systems, and methods. The functional units may be implemented in only hardware (e.g., customized circuitry) or in a combination of software and hardware (e.g., a microprocessor that executes software).

As used herein, the conjunction “or” generally refers to an inclusive “or,” though “or” may refer to an exclusive “or” if expressly indicated or if the context indicates that the “or” must be an exclusive “or.”

1. A system comprising:
one or more computer-readable media; and
one or more processors that are coupled to the one or more computer-readable media and that are configured to cause the system to
obtain a color-management profile for a printing device,
determine a gamut of the printing device based on the color-measurement profile, and
identify target measurement points in the gamut.

2. The system of claim 1, wherein the one or more processors are further configured to cause the system to determine respective printing-device values for the target measurement points based on the color-management profile.

3. The system of claim 2, wherein the one or more processors are further configured to cause the system to
obtain respective color measurements for patches that were printed according to the printing-device values, and
compute respective color differences between the target measurement points in the gamut and the color measurements.

4. The system of claim 1, wherein to identify the target measurement points in the gamut, the one or more processors are configured to cause the system to evenly sample polar coordinates in the gamut.

5. The system of claim 1, wherein to identify the target measurement points in the gamut, the one or more processors are configured to cause the system to evenly sample Cartesian coordinates in the gamut.

6. The system of claim 1, wherein to identify the target measurement points in the gamut, the one or more processors are configured to cause the system to randomly select coordinates in the gamut.

7. The system of claim 1, wherein the target measurement points include:
a white point in the gamut;
a black point in the gamut; and
a gray-center point in the gamut, wherein the gray-center point is halfway between the white point and the black point.

8. The system of claim 7, wherein the target measurement points further include:
a saturated-color point that has a maximum chroma of the gamut, and
a saturated-gray point between the white point and the black point that has a same lightness as the saturated-color point.

9. The system of claim 8, wherein the target measurement points further include:
a light-color point and a half-color point, both on a boundary of the gamut between the white point and the saturated-color point.

10. The system of claim 9, wherein the target measurement points further include:
a dark-color point on the boundary of the gamut between the black point and the saturated-color point,
a mid-light-color point,
a mid-half-color point, and
a mid-dark-color point.

11. The system of claim 10, wherein the target measurement points further include:
a mid-saturated-color point between the saturated-gray point and the saturated-color point,
a half-saturated-color-white point between the white point and the saturated-color point,
a light-saturated-color-white point between the white point and the saturated-color point, and
a half-saturated-color-black point between the black point and the saturated-color point.

12. A method comprising:
determining a gamut of a printing device based on a color-management profile of the printing device; and
identifying one or more target measurement points in the gamut.

13. The method of claim 12, further comprising:
determining respective printing-device values for the target measurement points based on the color-management profile,
obtaining respective color measurements for patches that were printed according to the printing-device values, and
computing respective color differences between the target measurement points in the gamut and the color measurements.

14. The method of claim 12, wherein identifying the one or more target measurement points in the gamut includes using color-vector projection to identify at least some of the one or more target measurement points in the gamut.

15. The method of claim 12, wherein the one or more target measurement points in the gamut include:
a white point it the gamut;
a black point in the gamut;
a gray-center point in the gamut, wherein the gray-center point is halfway between the white point and the black point; and
a saturated-color point that has a highest chroma of the gamut.

16. The method of claim 15, wherein the one or more target measurement points in the gamut further include:
a saturated-gray point, between the white point and the black point, that has a same lightness as the saturated-color point; and
a light-color point and a half-color point, both on a boundary of the gamut between the white point and the saturated-color point.

17. The method of claim 16, wherein the one or more target measurement points in the gamut further include:
a dark-color point on the boundary of the gamut between the black point and the saturated-color point,
a mid-light-color point,
a mid-half-color point,
a mid-dark-color point,
a mid-saturated-color point between the saturated-gray point and the saturated-color point,
a half-saturated-color-white point between the white point and the saturated-color point,
a light-saturated-color-white point between the white point and the saturated-color point, and
a half-saturated-color-black point between the black point and the saturated-color point.

18. One or more computer-readable storage media storing computer-executable instructions that, when executed by one or more computing devices, cause the one or more computing devices to perform operations that comprise:
determining a gamut of a printing device based on a color-management profile of the printing device; and
selecting one or more target measurement points in the gamut.

19. The one or more computer-readable storage media of claim 18, wherein the operations further comprise:
determining respective printing-device values for the target measurement points based on the color-management profile;
sending the printing-device values to the printing device;
obtaining respective color measurements for patches that were printed on a swatch according to the printing-device values; and
calculating respective color differences between the target measurement points in the gamut and the color measurements.

20. The one or more computer-readable storage media of claim 19, wherein the operations further comprise:
generating a user interface that describes the respective color differences.

21. The one or more computer-readable storage media of claim 18, wherein the target measurement points include:
a white point it the gamut,
a black point in the gamut,
a gray-center point in the gamut, wherein the gray-center point is halfway between the white point and the black point, and
a saturated-color point that has a highest chroma of the gamut.

22. The one or more computer-readable storage media of claim 21, wherein the target measurement points further include:
a saturated-gray point, between the white point and the black point, that has a same lightness as the saturated-color point;
a light-color point on a boundary of the gamut between the white point and the saturated-color point; and
a half-color point on the boundary of the gamut between the white point and the saturated-color point.
